(19) United States
(12) Patent Application Publication
(10) Pub. No.: US 2023/0388181 A1
(43) Pub. Date: Nov. 30, 2023

(54) INFORMATION PROCESSING APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Koji Inagaki, Tokyo (JP)

(21) Appl. No.: 18/200,713

(22) Filed: May 23, 2023

(30) Foreign Application Priority Data
May 31, 2022 (JP) 2022-088879

(51) Int. Cl. H04L 41/0806; H04W 24/02; H04W 12/08; H04W 12/06

(52) U.S. Cl. CPC H04L 41/0806; H04W 24/02; H04W 12/08; H04W 12/06

(57) ABSTRACT

A control method for an information processing apparatus capable of wirelessly communicating with a communication apparatus, includes: executing, based on a fact that a predetermined access point different from the information processing apparatus and different from the communication apparatus supports a network setup by a predetermined protocol, transmission control for transmitting, to the communication apparatus, a signal for causing the communication apparatus to start a predetermined operation for the network setup by the predetermined protocol; and executing processing for executing the network setup by the predetermined protocol in the information processing apparatus.

### BACKGROUND OF THE INVENTION

### Field of the Invention

The present invention relates to an information processing apparatus for performing setting concerning connection between apparatuses, a control method, and a non-transitory computer-readable storage medium.

### Description of the Related Art

In recent years, there are increasing cases in which a wireless communication function is mounted on electronic apparatuses such as a digital camera, a printer, and a portable telephone/smartphone and these apparatuses are connected to a wireless network and used as communication apparatuses. To connect the electronic apparatus to the wireless network, it is necessary to set various communication parameters such as an encryption method, an encryption key, an authentication method, and an authentication key. Therefore, setting of the communication parameters is complicated, and is difficult for the user of a digital camera or a printer. Thus, a mechanism for facilitating setting of the communication parameters is used. To prevent leakage of information of the communication parameters and the like, a mechanism of concealing the communication parameters by public-key cryptography and notifying a user terminal of them is also used.

As one mechanism, a mechanism of transmitting/receiving network information between apparatuses, which is called Wi-Fi Easy Connect (WEC) using Device Provisioning Protocol (DPP), is standardized by the Wi-Fi Alliance. In WEC, examples of a Bootstrapping method for triggering transmission/reception of network information are a QR code, BLE, and NFC, and communication is started by providing a public key to a communication partner apparatus.

Japanese Patent Laid-Open No. 2006-261938 describes a technique of facilitating setting of communication parameters in a communication terminal via the medium of a QR Code® image including information of the communication parameters. Japanese Patent Laid-Open No. 2019-180036 describes a technique in which a QR code is output to an output unit after a printer receives a specific signal from a terminal.

### SUMMARY OF THE INVENTION

The present invention provides a mechanism of improving convenience in an arrangement in which after a specific signal is transmitted to an apparatus, a network setup of the apparatus is performed by a predetermined method.

The present invention in one aspect provides a control method for an information processing apparatus capable of wirelessly communicating with a communication apparatus, comprising: executing, based on a fact that a predetermined access point different from the information processing apparatus and different from the communication apparatus supports a network setup by a predetermined protocol, transmission control for transmitting, to the communication apparatus, a signal for causing the communication apparatus to start a predetermined operation for the network setup by the predetermined protocol; and executing processing for executing the network setup by the predetermined protocol in the information processing apparatus.

According to the present invention, convenience is improved in an arrangement in which after a specific signal is transmitted to an apparatus, a network setup of the apparatus is performed by a predetermined method.

Further features of the present invention will become apparent from the following description of exemplary embodiments with reference to the attached drawings.

### BRIEF DESCRIPTION OF THE DRAWINGS

FIG. 1 is a block diagram showing the arrangement of a system including an information processing apparatus and a communication apparatus;

FIG. 2 is a sequence chart showing processing executed by the information processing apparatus and the communication apparatus;

FIG. 3 is a view showing a UI screen of the information processing apparatus;

FIG. 4 is a flowchart illustrating transmission control processing of a specific signal in the information processing apparatus;

FIGS. 5A to 5D are views each showing a UI screen of the information processing apparatus;

FIG. 6 is a flowchart illustrating transmission control processing of a specific signal in an information processing apparatus; and

FIG. 7 is a flowchart illustrating processing in a DPP waiting mode.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In an arrangement in which after a specific signal is transmitted to an apparatus, a network setup of the apparatus is performed by a predetermined method, even if the signal is transmitted in a case where the apparatus does not support the network setup by the predetermined method, the network setup is not performed.

According to the present disclosure, it is possible to improve convenience in an arrangement in which after a specific signal is transmitted to an apparatus, a network setup of the apparatus is performed by a predetermined method.

### First Embodiment

An information processing apparatus and a communication apparatus included in a communication system according to this embodiment will be described. In this embodiment, a smartphone is exemplified as the information processing apparatus but the present invention is not limited to this. For example, as the information processing apparatus, various kinds of apparatuses such as a portable terminal, a Personal Computer (PC), a tablet terminal, a Personal Digital Assistant (PDA), and a digital camera are applicable. In this embodiment, a printer is exemplified as the communication apparatus but the present invention is not limited to this, and various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a copying machine, a facsimile apparatus, a portable terminal, a smartphone, a laptop, a tablet terminal, a PDA, a digital camera, a music playback device, a television, a smart speaker, and the like are applicable. In addition, a multi-function peripheral having a plurality of functions such as a copying function, a FAX function, and a print function is applicable.

In this embodiment, if the information processing apparatus supports a function called Wi-Fi Easy Connect (to be referred to as WEC® hereinafter), it can execute this function. WEC is a function of executing a network setup of another apparatus using Device Provisioning Protocol (to be referred to as DPP hereinafter) defined by the Wi-Fi Alliance. Note that a network setup of another apparatus specifically indicates processing of connecting another apparatus to an access point forming a network. In WEC, an apparatus (to be referred to as a Configurator apparatus hereinafter) operating in the role of “Configurator” and an apparatus (to be referred to as an Enrollee apparatus hereinafter) operating in the role of “Enrollee” communicate with each other. Note that in this embodiment, the Configurator apparatus serves as an Initiator in DPP, and the Enrollee apparatus serves as a Responder in DPP. In Bootstrapping, the Configurator apparatus acquires Bootstrapping information from the Enrollee apparatus. To acquire the Bootstrapping information, a method using, for example, a QR co d e®, Bluetooth Low Energy (BLE), Near Field Communication (NFC), or other communication is used. The Bootstrapping information includes, for example, identification information (MAC address or the like) of the Enrollee apparatus, and public key information to be used to execute secure communication with the Enrollee apparatus. In this embodiment, the Bootstrapping information is described as “WEC associated information”. Note that other information may be processed as WEC associated information. Then, the Configurator apparatus executes wireless communication with the Enrollee apparatus using the acquired Bootstrapping information. More specifically, for example, the Configurator apparatus communicates with the Enrollee apparatus using the public key included in the Bootstrapping information. Furthermore, the Configurator apparatus generates a common key based on the information obtained by the communication, and transmits, to the Enrollee apparatus, information encrypted using the common key. Note that the transmitted information is specifically, for example, connection information for connection to the access point. Then, the Enrollee apparatus establishes wireless connection to the access point using the connection information received from the Configurator apparatus. Note that in network setup processing by WEC according to this embodiment, the information processing apparatus supporting WEC operates as the Configurator apparatus, and the communication apparatus supporting WEC operates as the Enrollee apparatus.

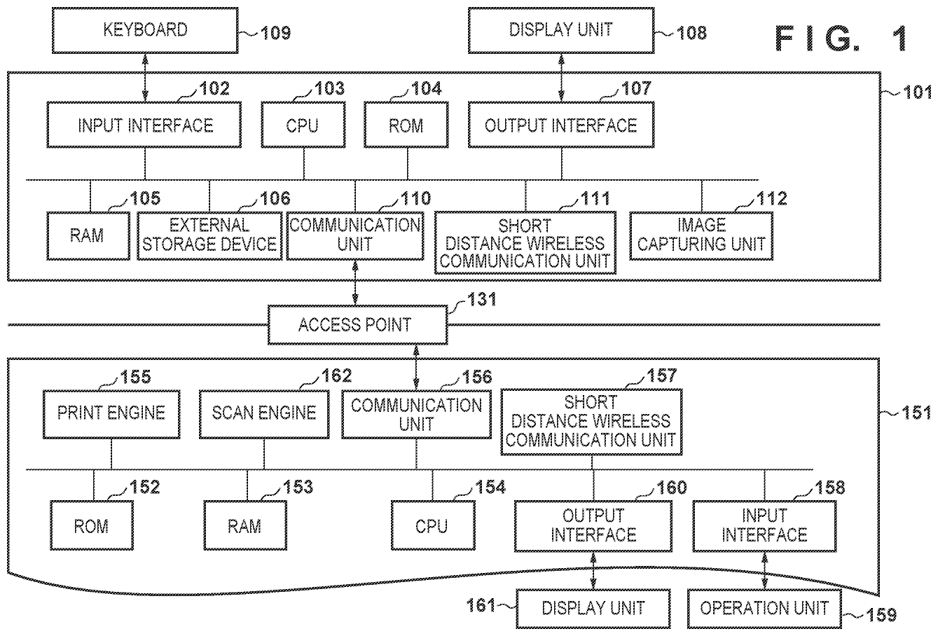

First, the arrangement of the information processing apparatus according to this embodiment and the communication apparatus communicable with the information processing apparatus according to this embodiment will be described with reference to a block diagram shown in FIG. 1. Although the following components are exemplified in this embodiment, this embodiment is applicable with respect to an apparatus communicable with the communication apparatus, and the present invention is not limited to the components shown in FIG. 1.

An information processing apparatus 101 is the information processing apparatus according to this embodiment. The information processing apparatus 101 includes an input interface 102, a CPU 103, a ROM 104, a RAM 105, an external storage device 106, an output interface 107, a display unit 108, a communication unit 110, a short distance wireless communication unit 111, and an image capturing unit 112. The CPU 103, the ROM 104, the RAM 105, and the like form a computer of the information processing apparatus 101.

The input interface 102 is an interface configured to accept data input and operation instructions from the user when an operation unit such as a keyboard 109 is operated. Note that the operation unit may include a physical keyboard and physical buttons, or may include a software keyboard and software buttons displayed on the display unit 108. That is, the input interface 102 may accept input (operation) from the user via the display unit 108.

The CPU 103 is a system control unit and controls the whole information processing apparatus 101. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and the work memory of the CPU 103.

The external storage device 106 stores an application program (to be referred to as a setting application hereinafter) configured to perform a network setup of a communication apparatus 151, a print information generation program that generates print information interpretable by the printing apparatus 151, and the like. The setting application is, for example, an application program configured to set an access point as the connection destination of the communication apparatus 151 by WEC or the like. Note that the setting application may have functions other than the network setup function. For example, the setting application may have a function of causing the communication apparatus 151 to execute printing, a function of scanning a document set in the communication apparatus 151, a function of confirming the state of the communication apparatus 151, and the like. The setting application is stored in the external storage device 106 by being installed from an external server by, for example, Internet communication via the communication unit 110. Furthermore, the external storage device 106 stores various kinds of programs such as an information transmission/reception control program to be transmitted/received to/from the communication apparatus 151 connected via the communication unit 110, and various kinds of information to be used by the programs.

The output interface 107 is an interface configured to perform control for causing the display unit 108 to display data or make a notification concerning the state of the information processing apparatus 101. The display unit 108 is formed by a Light-Emitting Diode (LED), a Liquid Crystal Display (LCD), or the like and displays data or makes a notification concerning the state of the information processing apparatus 101.

The communication unit 110 is a component connected to the apparatus such as the communication apparatus 151 or an access point 131 to execute data communication. For example, the communication unit 110 can be connected to an access point (not shown) in the communication apparatus 151. If the communication unit 110 and the access point in the communication apparatus 151 are connected, the information processing apparatus 101 and the communication apparatus 151 can communicate with each other. Note that the communication unit 110 may directly communicate with the communication apparatus 151 by wireless communication, or may perform communication via an external apparatus existing outside the information processing apparatus 101 and the communication apparatus 151. Note that examples of the external apparatus include an external access point (the access point 131 or the like) existing outside the information processing apparatus 101 and the communication apparatus 151, and an apparatus, other than the access point, that can relay communication. In this embodiment, as a wireless communication method used by the communication unit 110, Wireless Fidelity (Wi-Fi)® which is a communication standard based on the IEEE802.11 series is used. WEC described above can be executed by communication by the communication unit 110. In addition, for example, a device such as a wireless LAN router is used as the access point 131. Note that in this embodiment, the method of directly connecting the information processing apparatus 101 and the communication apparatus 151 without intervention of an external access point is called a direct connection method. In addition, the method of connecting the information processing apparatus 101 and the communication apparatus 151 via the external access point is called an infrastructure connection method.

The short distance wireless communication unit 111 is a component wirelessly connected to the apparatus such as the communication apparatus 151 in a short distance to execute data communication, and performs communication by a communication method different from that of the communication unit 110. The short distance wireless communication unit 111 can be connected to a short distance wireless communication unit 157 in the communication apparatus 151. As the communication method, for example, Near Field Communication (NFC), Bluetooth® Classic, Bluetooth Low Energy (BLE), Wi-Fi Aware, or the like is used.

The image capturing unit 112 operates when an application operating on the information processing apparatus 101 executes an image capturing function. If the application executes the image capturing function, for example, information acquired from the image capturing unit 112 is processed by the CPU 103, and displayed as a live view on the display unit 108. At this time, if the application executes an image capturing operation, information acquired from the image capturing unit 112 is processed by the CPU 103, and stored as a captured image in the RAM 105. Furthermore, if the application executes a QR code acquisition function, the information acquired from the image capturing unit 112 is processed by the CPU 103, and analyzed as a QR code, thereby acquiring various kinds of information included in the QR code. An example of the information included in the QR code is WEC associated information. Note that in this embodiment, a QR code is processed as an example of a two-dimensional code. In this embodiment, the information processing apparatus 101 executes WEC by the OS of the information processing apparatus 101 based on an execution instruction of network setup processing by the setting application.

The communication apparatus 151 serves as the communication apparatus of this embodiment. The communication apparatus 151 includes a ROM 152, a RAM 153, a CPU 154, a print engine 155, a scan engine 162, a communication unit 156, and the short distance wireless communication unit 157. The ROM 152, the RAM 153, the CPU 154, and the like form a computer of the communication apparatus 151.

The communication unit 156 includes, as the access point in the communication apparatus 151, an access point for connection to the apparatus such as the information processing apparatus 101. Note that the access point can be connected to the communication unit 110 of the information processing apparatus 101. If the communication unit 156 enables the access point, the communication apparatus 151 operates as the access point. Note that the communication unit 156 may directly, wirelessly be connected to the information processing apparatus 101 or may wirelessly be connected to the information processing apparatus 101 via the access point 131. In this embodiment, as the wireless communication method used by the communication unit 156, a communication standard based on the IEEE802.11 series is used. In the following description, Wireless Fidelity (Wi-Fi) (Wi-Fi communication) indicates a communication standard based on the IEEE802.11 series. If the communication apparatus 151 supports WEC, WEC described above is executed by communication by the communication unit 156. The communication unit 156 may include a hardware component functioning as an access point or may operate as an access point by software for functioning as an access point.

The communication apparatus 151 of this embodiment can operate in an infrastructure mode or a Peer-To-Peer (P2P) mode as a mode for performing communication using the communication unit 156.

The infrastructure mode is a mode in which the communication apparatus 151 communicates with another apparatus such as the information processing apparatus 101 via an external apparatus (for example, the access point 131) forming a network. Connection to the external access point, which is established by the communication apparatus 151 operating in the infrastructure mode, is called infrastructure connection hereinafter. In this embodiment, in the infrastructure connection, the communication apparatus 151 operates as a station and the external access point operates as a master. Note that in this embodiment, the master is an apparatus that decides a communication channel used in a network to which the master belongs, and the station is an apparatus that does not decide a communication channel used in a network to which the station belongs, and uses the communication channel decided by the master.

The P2P mode is a mode in which the communication apparatus 151 directly communicates with another apparatus such as the information processing apparatus 101 without intervention of an external apparatus forming a network. In this embodiment, the P2P mode includes an AP mode in which the communication apparatus 151 operates as an access point. In the AP mode, connection information (SSID and password) of the access point enabled in the communication apparatus 151 can arbitrarily be set by the user. Note that the P2P mode may include, for example, a WFD mode in which the communication apparatus 151 performs communication by Wi-Fi Direct (WFD). Note that which of a plurality of WFD-capable apparatuses operates as a master is decided in accordance with, for example, the Group Owner Negotiation procedure. Note that the master may be decided without executing the Group Owner Negotiation procedure. An apparatus that is a WFD-capable apparatus and serves as a master is called a Group Owner. Direct connection to another apparatus, which is established by the communication apparatus 151 operating in the P2P mode, is called direct connection. In this embodiment, in the direct connection, the communication apparatus 151 operates as a master and the other apparatus operates as a station.

Furthermore, in this embodiment, the communication apparatus 151 can operate in a network setup mode as a mode of executing a network setup of the communication apparatus 151 by accepting a predetermined operation from the user. If the communication apparatus 151 operates in the network setup mode, it uses the communication unit 156 to operate as a setup access point which is enabled during the operation in the network setup mode. The setup access point is an access point different from an access point enabled in the above-described AP mode. Furthermore, assume that the SSID of the setup access point includes a predetermined character string that can be recognized by the setting application of the information processing apparatus 101. Assume also that the setup access point is an access point that does not require a password for connection. In addition, assume that the communication apparatus 151 operating in the network setup mode uses a predetermined communication protocol (setup communication protocol) in communication with the information processing apparatus 101 connected to the setup access point. More specifically, the setup communication protocol is, for example, Simple Network Management Protocol (SNMP). Another practical example of the setup communication protocol is Hypertext Transfer Protocol (HTTP). If a predetermined time elapses after the start of the operation in the network setup mode, the communication apparatus 151 stops the operation in the network setup mode, and disables the setup access point. This is because the setup access point is an access point that does not require a password, as described above, and thus if the access point is enabled for a long time, an inappropriate apparatus has a high probability to request a connection. Note that the setup access point may be an access point that requires a password. In this case, a password used for connection to the setup access point is a fixed password (unchangeable by the user) that is grasped in advance by the setting application.

Furthermore, in this embodiment, the communication apparatus 151 can operate in a mode for executing a network setup of the communication apparatus 151 by a communication protocol different from the setup communication protocol. This embodiment assumes that the communication protocol different from the setup communication protocol is DPP described above, and this mode is called a DPP waiting mode. Upon receiving a network setup request by DPP from the information processing apparatus 101 in a state in which the communication apparatus 151 operates in the DPP waiting mode, the communication apparatus 151 executes a network setup by DPP. Therefore, in other words, the DPP waiting mode is a mode for waiting for a network setup request by DPP.

The short distance wireless communication unit 157 is a component wirelessly connected to the apparatus such as the information processing apparatus 101 in a short distance, and can be connected to, for example, the short distance wireless communication unit 111 in the information processing apparatus 101. As the communication method, for example, NFC, Bluetooth Classic, BLE, Wi-Fi Aware, or the like is used.

The CPU 154 is a system control unit and controls the whole communication apparatus 151. The RAM 153 is formed by an SRAM or the like, which needs a backup power supply. Note that the RAM 153 can store important data such as program control variables without volatilization because the data are held by a primary battery (not shown) for data backup. In addition, a memory area for storing setting information of the communication apparatus 151, management data of the communication apparatus 151, and the like is also provided in the RAM 153. Furthermore, the RAM 153 is used as the main memory and the work memory of the CPU 154, and functions as a reception buffer configured to temporarily store print information received from the information processing apparatus 101 or the like, or stores various kinds of information. The ROM 152 stores permanent data such as control programs to be executed by the CPU 154, data tables, and an OS program. In this embodiment, the control programs stored in the ROM 152 perform software execution control such as scheduling, task switch, and interrupt processing under the management of the embedded OS stored in the ROM 152.

Based on information stored in the RAM 153 or a print job received from the information processing apparatus 101 or the like, the print engine 155 forms an image on a print medium such as a paper sheet by applying a printing material such as ink onto the print medium, and outputs the print result. Note that in general, the data amount of the print job transmitted from the information processing apparatus 101 or the like is large, and thus it is required to use, for communication of the print job, a communication method that allows high-speed communication. Therefore, the communication apparatus 151 receives the print job via the communication unit 156 that can perform communication at a speed higher than that of the short distance wireless communication unit 157.

Based on an input from an operation unit 159 or a scan job received from the information processing apparatus 101 or the like, the scan engine 162 reads image data or document data from a set document or the like. The read data is stored as a scan result in the RAM 153 or transmitted to the information processing apparatus 101 or the like. Note that in general, the data amount of the scan result transmitted from the communication apparatus 151 to the information processing apparatus 101 or the like is large, and thus it is required to use, for communication of the scan result, a communication method that allows high-speed communication. Therefore, the communication apparatus 151 transmits the scan result via the communication unit 156 that can perform communication at a speed higher than that of the short distance wireless communication unit 157.

Note that a memory such as an external HDD or an SD card may be attached as an optional device to the communication apparatus 151, and information stored in the communication apparatus 151 may be stored in the memory.

An input interface 158 is an interface configured to accept data input and operation instructions from the user when the operation unit 159 such as a physical button is operated. Note that the operation unit 159 may include a software keyboard and software buttons displayed on a display unit 161. That is, the input interface 158 may accept input from the user via the display unit 161. An output interface 160 is an interface configured to perform control for causing the display unit 161 to display data or make a notification concerning the state of the communication apparatus 151. The display unit 161 is formed by a Light-Emitting Diode (LED), a Liquid Crystal Display (LCD), or the like and displays data or makes a notification concerning the state of the communication apparatus 151. Note that in this embodiment, the operation unit 159 and the display unit 161 are configured as an operation display unit formed from a touch panel display.

In this embodiment, the communication units 110 and 156 execute communication parameter sharing processing for sharing communication parameters between the apparatuses. The communication parameter sharing processing is processing in which a providing-side apparatus provides communication parameters for wireless communication to a reception-side apparatus, and can be performed in each of the infrastructure mode and the P2P mode. In this case, the communication parameters include, for example, wireless communication parameters necessary for wireless LAN communication, such as a Service Set Identifier (SSID) as a network identifier, an encryption method, an encryption key, an authentication method, and an authentication key. The communication parameters also include identification information such as a MAC address, a password, an IP address for communication on the IP layer, and information necessary for higher level services. The communication parameter sharing processing executed by the communication units 110 and 156 may be, for example, Wi-Fi Protected Setup (WPS) defined by the Wi-Fi Alliance. In the communication parameter sharing processing executed by the communication units 110 and 156, a method of safely transferring the communication parameters using public-key cryptography may be used.

The communication apparatus 151 also includes a barcode generation control unit. The barcode generation control unit is not shown in FIG. 1 but is implemented when, for example, the CPU 154 executes a program. The barcode generation control unit generates code information such as a barcode, a two-dimensional code, or a QR code, and executes control to display the generated code information on the display unit 161. The barcode generation control unit displays, on the display unit 161, a QR code or the like obtained by encoding information necessary to set the communication parameters. Note that the display unit 161 may be a component capable of displaying software buttons and the like as an input interface of the user.

The operation of the communication system including the above components will be described. In the following description, in an example, an arrangement will be described in which in a state where the information processing apparatus 101 is not connected to the external access point, the information processing apparatus 101 causes the image capturing unit 112 to capture the QR code displayed on the display unit 161 by the communication apparatus 151 and a network setup by WEC is performed using information of the captured QR code.

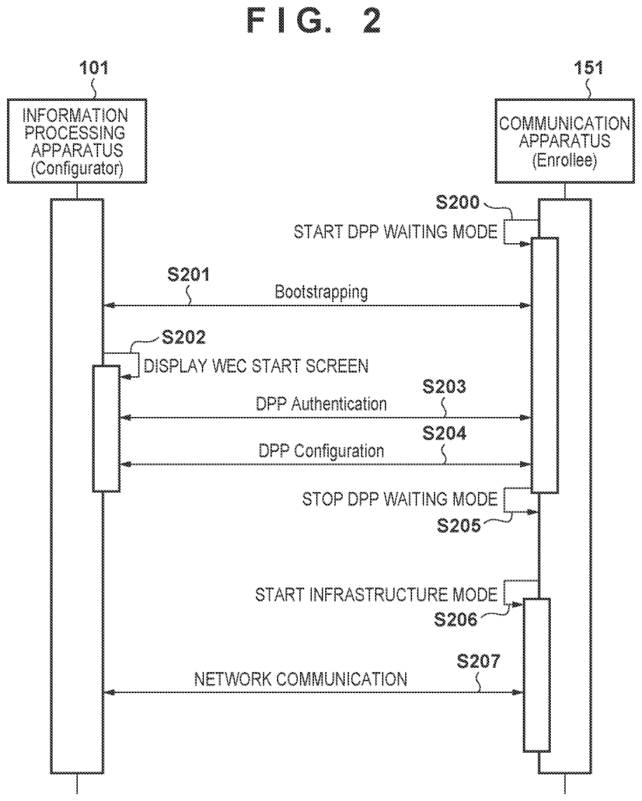

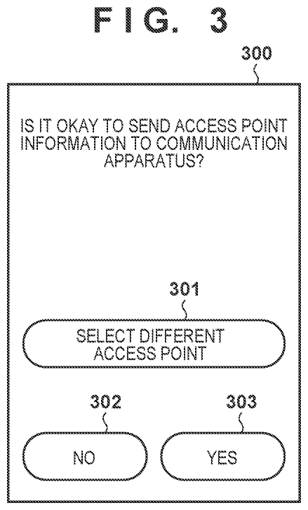

Processing executed by the information processing apparatus 101 and the communication apparatus 151 in WEC using DPP will be described with reference to FIGS. 2 and 3. A sequence shown in FIG. 2 is implemented when, for example, the CPU of each apparatus reads out a program stored in the ROM of each apparatus, the external storage device, or the like to the RAM of each apparatus and executes the program.

In S200, the communication apparatus 151 starts the DPP waiting mode. A trigger for starting the DPP waiting mode may be, for example, a user operation via the operation unit 159 or reception of a specific signal from an external apparatus such as the information processing apparatus 101. Practical examples of the reception of the specific signal from the external apparatus such as the information processing apparatus 101 are reception of a specific BLE beacon and reception of specific wireless LAN communication. After the start of the DPP waiting mode, it is possible to read WEC associated information. For example, if a QR code is used for Bootstrapping indicated in S201, the communication apparatus 151 generates a QR code based on the WEC associated information, and displays it on the display unit 161.

Note that if the DPP waiting mode is started in S200, the communication apparatus 151 may simultaneously operate in another mode. For example, the communication apparatus 151 may simultaneously operate in the above-described network setup mode.

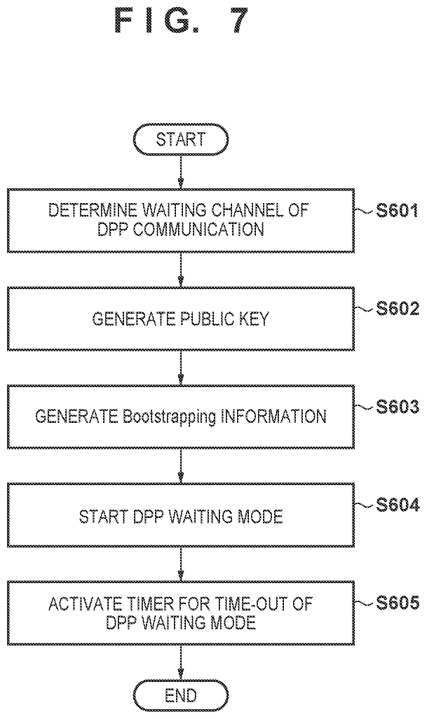

Processing of the DPP waiting mode executed by the communication apparatus 151 in WEC using DPP will be described with reference to FIG. 7. A flowchart shown in FIG. 7 is implemented when, for example, the CPU 154 of the communication apparatus 151 reads out a program stored in the ROM 152 or the like to the RAM 153 and executes the program.

FIG. 7 is a flowchart illustrating the contents of DPP waiting mode start processing. The flowchart shown in FIG. 7 starts based on, for example, the start of the DPP waiting mode in the communication apparatus 151 in S200.

In step S601, the CPU 154 decides a waiting channel of DPP communication. The waiting channel of DPP communication means a channel that waits for a network setup request by DPP, which is transmitted from the information processing apparatus 101. The same channel is used in the DPP Configuration. Note that which channel is used as the waiting channel of DPP communication may be set, for example, by the user from the operation screen of the communication apparatus 151.

In step S602, the CPU 154 generates the above-described public key information used to perform secure communication with the information processing apparatus 101.

In step S603, the CPU 154 generates the above-described Bootstrapping information. The Bootstrapping information includes, for example, the identification information (the MAC address or the like) of the communication apparatus 151, information concerning the waiting channel of the DPP communication, and the public key information generated in step S602.

In step S604, the CPU 154 starts the DPP waiting mode. If the DPP waiting mode is started, communication in the DPP Authentication can be performed between the communication apparatus 151 and the information processing apparatus 101.

In step S605, the CPU 154 activates a timer for a time-out of the DPP waiting mode. Note that if a predetermined time elapses from the start of the operation in the DPP waiting mode, the CPU 154 stops the operation in the DPP waiting mode. By stopping the operation in the DPP waiting mode, the process transitions to, for example, network setup processing using the network setup protocol.

Referring back to FIG. 2, in S201, the information processing apparatus 101 acquires the WEC associated information as the Bootstrapping information. For example, if a QR code is used to acquire the Bootstrapping information, the information processing apparatus 101 executes a QR code capturing function in the setting application. The QR code capturing function captures the QR code using the image capturing unit 112, and analyzes the QR code from the captured image. This allows the setting application to acquire the WEC associated information included in the QR code.

In S202, the information processing apparatus 101 starts WEC using DPP by the function of the OS. More specifically, first, the information processing apparatus 101 instructs, from the setting application, the OS to activate a WEC application, thereby activating the WEC application. Thus, the WEC application operates in the foreground and the setting application operates in the background. Note that, for example, execution of the instruction corresponds to an instruction to execute WEC. Thus, the information processing apparatus 101 displays a WEC start screen by the WEC application. Note that the WEC application is a program installed in advance in the information processing apparatus 101, and is a program provided by the OS vendor of the information processing apparatus 101. If the WEC application is activated, the WEC associated information acquired by the setting application is provided to the WEC application.

FIG. 3 shows an example of the WEC start screen displayed by the WEC application. Regions 301, 302, and 303 are displayed on a WEC start screen 300. The region 301 is a region for changing an access point set as a setting target of WEC. Note that before the region 301 is operated, the access point set as the setting target of WEC is the access point currently connected to the information processing apparatus 101, and is, for example, the access point 131. If the region 301 is selected, the information processing apparatus 101 displays a list of access points, and newly sets an access point selected from the list by the user as the setting target of WEC. Note that the list of access points includes access points to which the information processing apparatus 101 has been connected once. The region 302 is a region for accepting a cancel instruction of execution of WEC, and the region 303 is a region for accepting an execution instruction of WEC. If the region 302 is operated, the information processing apparatus 101 ends the processing shown in the sequence chart. If the region 303 is pressed, the information processing apparatus 101 advances to S203. In this embodiment, as another arrangement example, the screen shown in FIG. 3 need not be displayed. That is, the process may advance to S203 even in a state in which the region 303 is not pressed.

In S202, the WEC application of the information processing apparatus 101 executes API for WEC using the WEC associated information and information concerning the access point set as the setting target of WEC, thereby instructing the OS to execute WEC. Then, in S203, processing called DPP Authentication is executed between the information processing apparatus 101 and the communication apparatus 151 by the function of the OS. In the DPP Authentication, authentication information, information used to encrypt information, and the like are communicated between the information processing apparatus 101 and the communication apparatus 151, thereby authenticating communication between the apparatuses. Note that various kinds of information transmitted from the information processing apparatus 101 in the communication of the DPP Authentication are encrypted based on the WEC associated information acquired from the communication apparatus 151 by the information processing apparatus 101. More specifically, in the DPP Authentication, first, the information processing apparatus 101 transmits an Authentication Request as a network setup request by DPP. Since the communication apparatus 151 operating in the DPP waiting mode is operating in the DPP waiting mode that is a mode for waiting for the Authentication Request, the communication apparatus 151 receives the Authentication Request transmitted from the information processing apparatus 101. Upon receiving the Authentication Request, the communication apparatus 151 attempts to decrypt the received Authentication Request using a decryption key currently held by the communication apparatus. If the decryption succeeds, the communication apparatus 151 transmits an Authentication response to the information processing apparatus 101, thereby authenticating communication with the information processing apparatus 101. Note that if the information processing apparatus 101 cannot acquire correct WEC associated information, and cannot encrypt the information correctly, decryption by the communication apparatus 151 fails. Therefore, authentication fails, and no Authentication response is transmitted. When the information processing apparatus 101 receives the Authentication response, the DPP Authentication is completed. Furthermore, in the DPP Authentication, communication is executed using DPP.

Next, in S204, processing called DPP Configuration is executed between the information processing apparatus 101 and the communication apparatus 151 by the function of the OS of the information processing apparatus 101. In the DPP Configuration, the information processing apparatus 101 transmits connection information for connection to the access point set as the setting target of WEC to the communication apparatus 151 by WEC. Note that the connection information includes at least one or more of pieces of information representing the SSID, password, and encryption method of the access point set as the setting target of WEC. The password transmitted at this time is information input by the user on a screen displayed by an application supported by the OS when the connection between the information processing apparatus 101 and the access point is established. This is information held by the OS when the connection between the information processing apparatus 101 and the access point is established. Furthermore, the password is information that is not held by the setting application. Since the password transmitted at this time is information already held by the OS, and the DPP Configuration is processing executed by the OS, the password need not newly be input by the user on the screen displayed by the setting application. In this embodiment, when the connection information is transmitted by WEC, the password can be transmitted to the communication apparatus 151 by secure communication without newly accepting the input of the password from the user on the screen displayed by the setting application. Note that even in the DPP Configuration, communication is executed using DPP.

In S205, upon completion of the DPP Configuration, the communication apparatus 151 ends the DPP waiting mode. The DPP waiting mode is ended by, for example, the end of display of the QR code.

In S206, upon acquiring the connection information in the DPP Configuration, the communication apparatus 151 transitions to the infrastructure mode. If the communication apparatus 151 operates in the network setup mode at this time, it ends the network setup mode. The communication apparatus 151 attempts to perform connection to the access point corresponding to the connection information using the acquired connection information. If the connection succeeds, the communication apparatus 151 can execute communication via the network formed by the connected access point from then on. Note that the communication via the network formed by the connected access point is executed by a protocol (more specifically, for example, Port 9100, SNMP, HTTP, or a protocol unique to the vendor of the communication apparatus 151) different from DPP. Note that the communication apparatus 151 may transmit, to the information processing apparatus 101, information representing whether connection to the access point corresponding to the connection information acquired by WEC succeeds or not. Furthermore, if connection to the access point corresponding to the connection information acquired by WEC fails, information representing the cause of the failure may be transmitted to the information processing apparatus 101. The information transmission may be executed using DPP. Note that the connection to the access point corresponding to the acquired connection information fails because a communication error occurs in WEC, the access point cannot be found, or the WEC associated information acquired from the communication apparatus 151 is not appropriate information. The connection fails also because, for example, the encryption method used for connection to the access point set as the setting target of WEC is an encryption method that is not supported by the communication apparatus 151. The connection fails also because, for example, the encryption method used for connection to the access point set as the setting target of WEC is an encryption method that is not supported by WEC. Note that the information processing apparatus 101 may display, on the display unit 108, information representing whether connection between the communication apparatus 151 and the access point corresponding to the connection information acquired by WEC succeeds or not. If the connection between the communication apparatus 151 and the access point corresponding to the connection information acquired by WEC fails, information representing the cause of the failure may be displayed on the display unit 108.

In S207, the information processing apparatus 101 switches, based on the end of the execution of WEC, the application operating in the foreground from the WEC application to the setting application. Then, the information processing apparatus 101 searches for the communication apparatus 151 on the network to which the information processing apparatus 101 itself belongs. This processing is implemented by the setting application that has received, from the OS, a notification representing that execution of WEC is ended. If the communication apparatus 151 is found, the information processing apparatus 101 requests capability information from the communication apparatus 151, and the communication apparatus 151 transmits the capability information to the information processing apparatus 101. Thus, the information of the communication apparatus 151 is registered on the setting application, and communication with the communication apparatus 151 can be executed by the setting application from then on. More specifically, for example, a print job can be transmitted to the communication apparatus 151 by the setting application. Note that at this time, if the information processing apparatus 101 belongs to the network formed by the access point to which the communication apparatus 151 is connected, communication between the information processing apparatus 101 and the communication apparatus 151 can be executed via the access point. Furthermore, if communication between the information processing apparatus 101 and the communication apparatus 151 cannot be executed because, for example, the access point to which the communication apparatus 151 is connected is not the access point to which the information processing apparatus 101 is connected, the request or acquisition of capability information is omitted. Note that the communication in S207 is executed using, for example, a communication protocol different from DPP and the setup communication protocol. After that, the information processing apparatus 101 ends the processing shown in the sequence chart.

Note that a form in which the WEC start screen is displayed by the WEC application, and the WEC application executes API of WEC to instruct the OS to execute WEC has been described above. However, the present invention is not limited to this form. For example, the WEC start screen may be displayed by the setting application. In addition, the setting application may execute API of WEC to instruct the OS to execute WEC.

The method using the QR code has been exemplified as the configuration for acquiring the Bootstrapping information. However, the present invention is not limited to this form. For example, short distance wireless communication such as NFC or BLE may be used as the configuration for acquiring the Bootstrapping information. As another configuration, communication by a communication protocol such as SNMP or HTTP via the setup access point activated in the DPP waiting mode may be used.

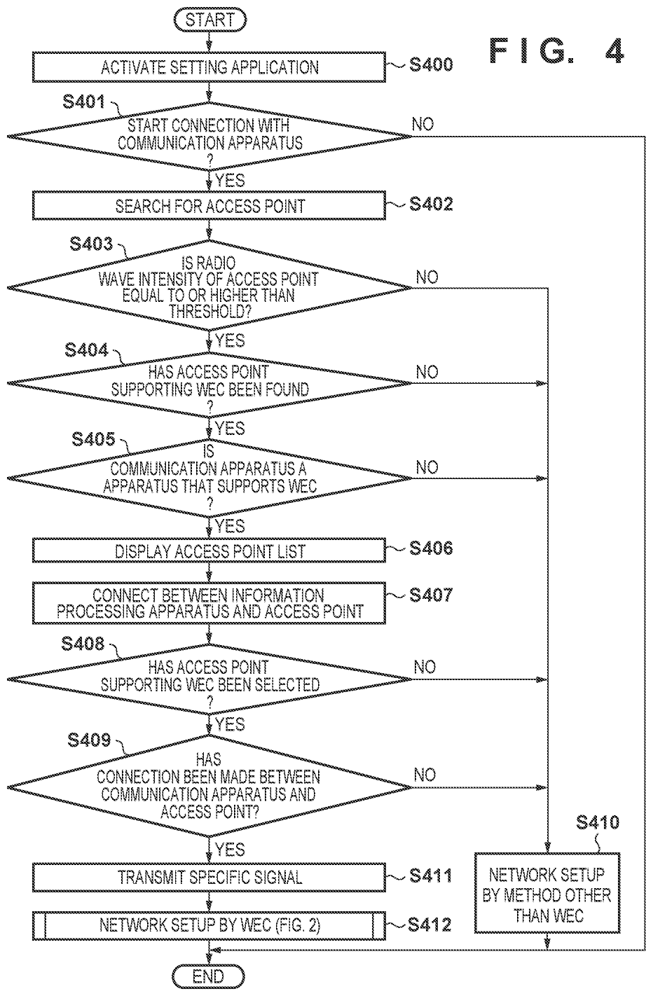

Next, a sequence of controlling processing of transmitting a specific signal to the communication apparatus 151 to perform a network setup by WEC and processing of transmitting no specific signal to the communication apparatus 151 in a state in which the information processing apparatus 101 is not connected to the external access point will be described with reference to FIGS. 4, 5A to 5D, 6, and 7.

FIG. 4 is a flowchart illustrating transmission control processing of a specific signal according to this embodiment. The processing shown in FIG. 4 is implemented when, for example, the CPU 103 reads out a program stored in the ROM 104 to the RAM 105 and executes the program.

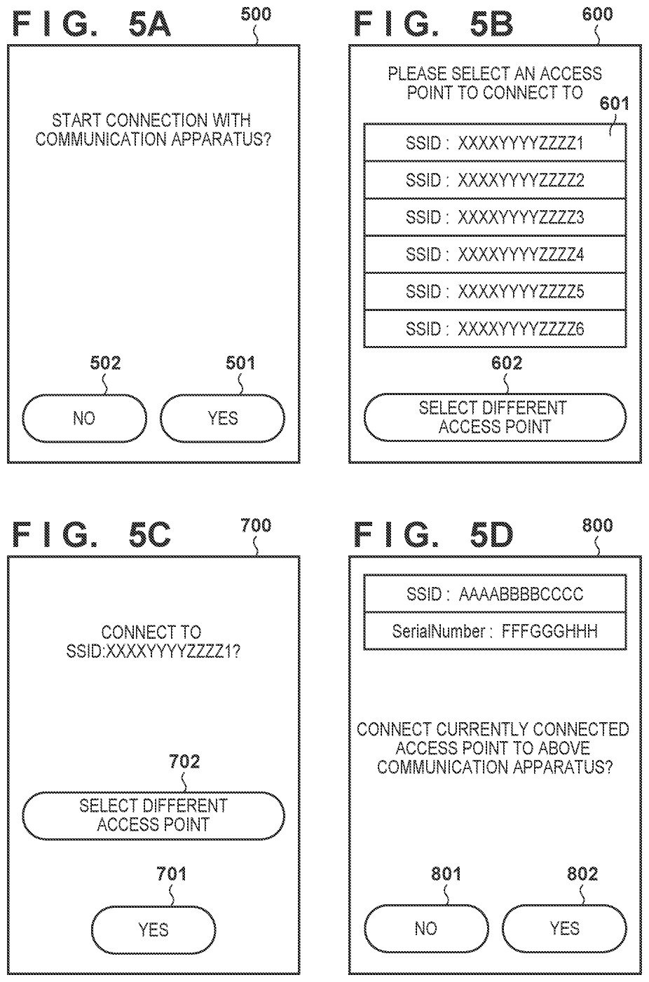

In step S400, the information processing apparatus 101 activates the setting application by a user operation. In step S401, the setting application displays a screen for accepting an instruction indicating whether to execute connection between the information processing apparatus 101 and the communication apparatus 151. Then, the setting application determines whether to start connection to the communication apparatus 151. Note that connection to the communication apparatus 151 at this time indicates connection for performing a network setup of the communication apparatus 151. FIG. 5A is a view showing an example of a screen for starting connection to the communication apparatus 151, which is displayed by the setting application. Regions 501 and 502 are displayed on a connection start screen 500. The region 501 is a region for accepting an instruction to start connection to the communication apparatus 151. The region 502 is a region for accepting an instruction not to start connection to the communication apparatus 151. In step S401, if the pressing of the region 502 is detected, the setting application determines not to start connection to the communication apparatus 151. Then, the processing shown in FIG. 4 ends without transmitting a specific signal from the information processing apparatus 101 to the communication apparatus 151. On the other hand, if the pressing of the region 501 is detected, the setting application determines to start connection to the communication apparatus 151, and advances to step S402.

In step S402, the setting application executes an access point search to search for an access point existing around the information processing apparatus 101. At this time, an access point search may be executed by a passive scan that receives a beacon at a predetermined interval or by an active scan that transmits a Probe Request and receives a Probe Response.

Next, in step S403, the setting application determines whether, as a result of the access point search, the radio wave intensity of the detected access point is equal to or higher than a threshold. Note that a practical example of the radio wave intensity is a Signal Noise Ratio (SNR). If it is determined in step S403 that the radio wave intensity is lower than the threshold, the setting application transmits no specific signal. Then, in step S410, the setting application executes a network setup of the communication apparatus 151 using a network setup method other than WEC. As the network setup method other than WEC, for example, a direct connection method of directly connecting the information processing apparatus 101 and the communication apparatus 151 or a connection method by BLE or the like may be used. As described above, according to this embodiment, it is possible to prevent a failure of the network setup caused by low radio wave intensity.

On the other hand, if it is determined that the radio wave intensity of the access point is equal to or higher than the threshold, the setting application determines, in step S404, whether an access point supporting WEC is detected. For example, the determination processing in step S404 may be performed based on whether a beacon advertised by the access point in step S402 or AKM of a Probe Response includes information indicating DPP. Note that AKM is an abbreviation for Authentication and Key Management. If it is determined in step S404 that the detected access point does not support WEC, the setting application transmits no specific signal. Then, in step S410, the setting application executes a network setup of the communication apparatus 151 using the network setup method other than WEC. As described above, according to this embodiment, it is possible to prevent a failure of the network setup caused when the information processing apparatus 101 transmits a specific signal although the detected access point does not support WEC.

On the other hand, if it is determined that the access point supporting WEC is detected, the setting application determines, in step S405, whether the communication apparatus 151 is an apparatus supporting WEC. An example of determining whether the communication apparatus 151 is an apparatus supporting WEC will be described.

For example, based on the fact that the SSID of the access point found in step S402 includes a specific character string representing the communication apparatus 151 and supporting of WEC, it may be determined that the communication apparatus 151 is an apparatus supporting WEC.

Furthermore, for example, based on the fact that the SSID of the access point found in step S402 includes a specific character string representing the communication apparatus 151 and the fact that the beacon or Probe Response includes a character string representing supporting of WEC, it may be determined that the communication apparatus 151 is an apparatus supporting WEC.

For example, to determine whether the communication apparatus 151 supports WEC, communication not shown in FIG. 4 may be executed. For example, direct connection may be performed between the information processing apparatus 101 and the communication apparatus 151, and the information processing apparatus 101 may acquire the capability of the communication apparatus 151, and then determine, based on the acquired capability, whether the communication apparatus 151 is an apparatus supporting WEC.

Furthermore, for example, based on information held in the nonvolatile memory of the information processing apparatus 101, it may be determined whether the first external apparatus 151 is an apparatus supporting WEC. For example, assume that when the information processing apparatus 101 was connected to the communication apparatus 151 in the past, the information processing apparatus 101 held the capability of the communication apparatus 151 in the nonvolatile memory. In this case, the information processing apparatus 101 detects, based on the SSID found in step S402, that the communication apparatus 151 exists around the information processing apparatus 101. In step S405, using the capability of the communication apparatus 151 held in the nonvolatile memory, the information processing apparatus 101 may determine whether the communication apparatus 151 is an apparatus supporting WEC.

If it is determined in step S405 that the communication apparatus 151 is an apparatus not supporting WEC, the setting application transmits no specific signal. In step S410, the setting application executes a network setup of the communication apparatus 151 using the network setup method other than WEC. As described above, according to this embodiment, it is possible to prevent the communication apparatus unintended by the user from displaying a QR code or the like when the information processing apparatus 101 transmits a specific signal although the communication apparatus 151 does not support WEC.

On the other hand, if it is determined that the communication apparatus 151 is an apparatus supporting WEC, the setting application displays an access point list screen in step S406. FIG. 5B is a view showing an example of the access point list screen displayed by the setting application. Regions 601 and 602 are displayed on an access point list screen 600. The region 601 is a region for accepting selection of an access point to which connection processing is performed, and displays a list of the SSIDs of the access points. Upon accepting selection of one of the SSIDs in the region 601, the setting application starts connection processing between the corresponding access point and the information processing apparatus 101.

The access point supporting WEC may preferentially be displayed so that the user easily selects the access point supporting WEC. For example, the access point supporting WEC may be displayed as the SSID (SSID: XXXXYYYYZZZZ1) at the top of the region 601. Furthermore, a message such as “recommended” may be displayed with the SSID of the access point supporting WEC, or the SSID of the access point supporting WEC may be made identifiable by, for example, coloring the SSID character string. This arrangement can make it easy to select the access point supporting WEC. In other words, it is possible to prevent the user from unintentionally selecting the access point not supporting WEC. Note that if the region 602 is pressed, it is possible to accept designation of an access point not displayed in the list in the region 601. For example, an access point not displayed in the list in the region 601 may be displayed, or an access point search may be executed again and a search result may be displayed.

To make it easy to select the access point supporting WEC, an access point connection confirmation screen 700 shown in FIG. 5C may be displayed instead of the screen shown in FIG. 5B. The SSID of the access point supporting WEC is displayed on the access point connection confirmation screen 700. A region 701 is a region for accepting an instruction to perform connection to the access point of the displayed SSID. If the region 701 is pressed, connection processing between the information processing apparatus 101 and the access point of the displayed SSID starts. A region 702 is a region for accepting designation of another access point that is not displayed. If the region 702 is pressed, another access point that is not displayed may be displayed, or another access point supporting WEC may be displayed. Alternatively, an access point search may be executed again, and an access point supporting WEC, different from the displayed access point, may be displayed. Note that in this example, the access point of the communication apparatus 151 is not a display target in step S406.

In step S407, the setting application executes connection between the information processing apparatus 101 and the access point selected in step S406. At this time, to connect the access point and the information processing apparatus 101, the user may be prompted to input the password of the access point to the information processing apparatus 101.

In step S408, the setting application determines whether the access point supporting WEC has been selected in step S406. An arrangement of performing determination based on the access point selected in step S406 is explained but another determination arrangement may be used. For example, an arrangement of performing determination based on the access point connected in step S407 may be used. That is, it may be determined whether the access point connected in step S407 supports WEC.

If it is determined in step S408 that the access point supporting WEC has not been selected, the setting application transmits no specific signal. Then, in step S410, the setting application executes a network setup of the communication apparatus 151 using the network setup method other than WEC.

On the other hand, if it is determined that the access point supporting WEC has been selected, the setting application displays, in step S409, a screen for confirming connection between the communication apparatus 151 and the access point. FIG. 5D is a view showing an example of the connection confirmation screen displayed by the setting application. The SSID of the communication apparatus 151 and the serial number of the communication apparatus 151 are displayed on a connection confirmation screen 800.

A region 801 is a region for accepting an instruction not to execute connection processing between the communication apparatus 151 and the access point using the network setup method by WEC. If the region 801 is pressed, the setting application executes, in step S410, a network setup of the communication apparatus 151 using the network setup method other than WEC. Note that the SSID of the communication apparatus 151 displayed on the connection confirmation screen 800 is, for example, the SSID of the communication apparatus 151 found in step S402 and determined, in step S405, as an apparatus supporting WEC. The displayed serial number of the communication apparatus 151 is, for example, a serial number included in the above-described capability of the communication apparatus 151 acquired by the information processing apparatus 101. Furthermore, a MAC address may be displayed instead of the serial number. If the MAC address is displayed, for example, it may be acquired from BSSID included in the Probe Response or the beacon acquired in the access point search in step S402. By displaying the serial number, it is possible to make the user recognize to transmit a specific signal to an apparatus intended by the user. The serial number is displayed on the connection confirmation screen 800 but need not be displayed.

A region 802 is a region for accepting an instruction to execute connection processing between the communication apparatus 151 and the access point using the network setup method by WEC. If the region 802 is pressed, the setting application starts, in step S411, network setup processing of the communication apparatus 151 by WEC. First, the setting application transmits a specific signal to the communication apparatus 151. In this embodiment, the specific signal is, for example, a Service Discovery Request or a Probe Request (that designates the SSID of the communication apparatus 151) of the WFD method.

In step S412, as described with reference to FIG. 2, a network setup of the communication apparatus 151 by WEC is executed. The processing in step S412 corresponds to the processing shown in FIG. 2. That is, as described with reference to FIG. 2, the communication apparatus 151 starts the DPP waiting mode upon receiving the specific signal, and displays a QR code or the like. After that, the information processing apparatus 101 ends the processing shown in FIG. 4. Note that the sequence of executing the determination processes in steps S401, S403, S404, S405, S408, and S409 and deciding the presence/absence of transmission of a specific signal in accordance with the determination results has been explained but some of the determination processes need not be executed. In the above description, each processing shown in FIG. 4 is executed by an instruction from the setting application. However, each processing may be executed by an instruction from the WEC application or the OS instead of the setting application.

As described above, in this embodiment, if a predetermined condition is satisfied, the information processing apparatus 101 transmits a specific signal for starting the DPP waiting mode to the communication apparatus 151. For example, if the communication apparatus 151 is an apparatus supporting WEC and the access point connected to the communication apparatus 151 supports WEC, the information processing apparatus 101 transmits a specific signal for starting the DPP waiting mode to the communication apparatus 151. That is, if it is impossible to execute a network setup by WEC, the information processing apparatus 101 transmits no specific signal. Therefore, if it is impossible to execute a network setup by WEC, the information processing apparatus 101 can execute control not to use a resource (CPU) to transmit a specific signal. According to this embodiment, even if the user unintentionally attempts to perform WEC connection to an apparatus not supporting WEC in a status in which an external apparatus supporting WEC and an external apparatus not supporting WEC are mixed around the information processing apparatus 101, the information processing apparatus 101 transmits no specific signal. This arrangement can prevent another apparatus supporting WEC and unintended by the user from displaying a QR code in response to a specific signal.

### Second Embodiment

In the second embodiment, the difference from the first embodiment will be described below. The first embodiment has explained a case where the processing shown in FIG. 4 starts in a state in which the information processing apparatus 101 is not connected to the external access point, and control is executed to switch between processing of transmitting a specific signal to the communication apparatus 151 to perform a network setup by WEC and processing of transmitting no specific signal. In this embodiment, processing of controlling to switch between the above two processes is started in a state in which an information processing apparatus 101 is connected to an external access point.

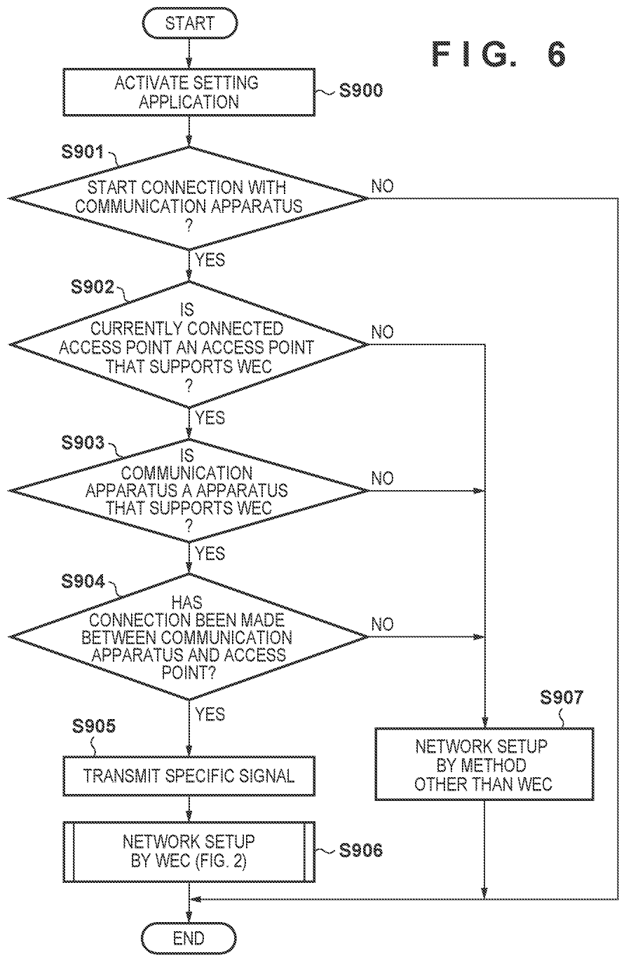

FIG. 6 is a flowchart illustrating transmission control processing of a specific signal according to this embodiment. The processing shown in FIG. 6 is implemented when, for example, a CPU 103 reads out a program stored in a ROM 104 to a RAM 105 and executes the program.

In step S900, the information processing apparatus 101 activates a setting application by a user operation. In step S901, the setting application displays a screen for accepting an instruction indicating whether to perform connection between the information processing apparatus 101 and a communication apparatus 151. In step S900, a connection start screen 500 shown in FIG. 5A is displayed, similar to the first embodiment. Then, the setting application determines whether to start connection to the communication apparatus 151. In step S901, if the pressing of a region 502 is detected, the setting application determines not to start connection to the communication apparatus 151. Then, the processing shown in FIG. 6 ends without transmitting a specific signal from the information processing apparatus 101. On the other hand, if the pressing of a region 501 is detected, the setting application determines to start connection to the communication apparatus 151, and advances to step S902.

In step S902, the setting application determines whether the access point currently connected to the information processing apparatus 101 is an access point supporting WEC. For example, the determination processing in step S902 may be performed based on whether DPP is included in AKM of a Probe Response or a beacon advertised by the connected access point in the past. In the determination processing in step S902, information stored in a nonvolatile memory of the information processing apparatus 101 may be used. Although not shown in FIG. 6, the determination processing in step S902 may be performed for the currently connected access point based on information acquired by executing communication for acquiring AKM.

If it is determined in step S902 that the access point currently connected to the information processing apparatus 101 does not support WEC, the setting application transmits no specific signal. In step S907, the setting application executes a network setup of the communication apparatus 151 using a network setup method other than WEC. As described above, according to this embodiment, it is possible to prevent a failure of the network setup caused when the information processing apparatus 101 transmits a specific signal although the access point currently connected to the information processing apparatus 101 does not support WEC. Step S907 assumes infrastructure connection via an access point as an example but direct connection without intervention of an access point may be used. Furthermore, the processes in step S402 and subsequent steps of FIG. 4 may be executed to search for an access point supporting WEC, different from the access point currently connected to the information processing apparatus 101. That is, the network setup by WEC may be prioritized over a network setup by another method.

On the other hand, if it is determined in step S902 that the access point currently connected to the information processing apparatus 101 supports WEC, the setting application determines, in step S903, whether the communication apparatus 151 is an apparatus supporting WEC, similar to step S405 of FIG. 4. Note that in FIG. 4, an access point search is executed before the processing in step S405. However, before the processing in step S903, there exists the access point currently connected to the information processing apparatus 101, and thus no access point search is executed. However, in this embodiment as well, an access point search may be executed before the processing in step S903, and the determination processing in step S903 may be performed using the search result. If it is determined in step S903 that the communication apparatus 151 is not an apparatus supporting WEC, the setting application transmits no specific signal. Then, in step S907, the setting application executes a network setup of the communication apparatus 151 using the network setup method other than WEC.

On the other hand, if it is determined in step S903 that the communication apparatus 151 is an apparatus supporting WEC, the setting application displays, in step S904, a screen for confirming connection between the communication apparatus 151 and the access point. In step S904, a connection confirmation screen 800 shown in FIG. 5D is displayed, similar to the first embodiment. After that, steps S905 and S906 are the same as steps S411 and S412 of FIG. 4 and a description thereof will be omitted.

As described above, according to this embodiment, if the communication apparatus 151 is an apparatus supporting WEC and the access point currently connected to the information processing apparatus 101 supports WEC, the information processing apparatus 101 transmits a specific signal. This arrangement can prevent the information processing apparatus 101 from transmitting a specific signal although it is impossible to execute a network setup by WEC.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-088879, filed May 31, 2022, which is hereby incorporated by reference herein in its entirety.

What is claimed is:

1. A control method for an information processing apparatus capable of wirelessly communicating with a communication apparatus, comprising:
executing, based on a fact that a predetermined access point different from the information processing apparatus and different from the communication apparatus supports a network setup by a predetermined protocol, transmission control for transmitting, to the communication apparatus, a signal for causing the communication apparatus to start a predetermined operation for the network setup by the predetermined protocol; and
executing processing for executing the network setup by the predetermined protocol in the information processing apparatus.

2. The method according to claim 1, wherein in a case where the predetermined access point does not support the network setup by the predetermined protocol, the transmission control is not executed.

3. The method according to claim 1, wherein the transmission control is executed based on a fact that the predetermined access point different from the information processing apparatus and different from the communication apparatus supports the network setup by the predetermined protocol and the communication apparatus supports the network setup by the predetermined protocol.

4. The method according to claim 1, wherein the predetermined access point is an access point to which the information processing apparatus is connected.

5. The method according to claim 1, wherein the predetermined operation is an operation in a state in which communication between the communication apparatus and the information processing apparatus for the network setup by the predetermined protocol is executable.

6. The method according to claim 5, wherein
the predetermined protocol is Device Provisioning Protocol (DPP), and
the communication between the communication apparatus and the information processing apparatus for the network setup by the predetermined protocol is communication in DPP Authentication.

7. The method according to claim 1, wherein the predetermined operation is an operation of displaying a two-dimensional code for causing the information processing apparatus to acquire information for the network setup by the predetermined protocol.

8. The method according to claim 5, further comprising acquiring, based on a two-dimensional code captured by the information processing apparatus, information for the network setup by the predetermined protocol.

9. The method according to claim 5, wherein
the predetermined protocol is Device Provisioning Protocol (DPP), and
information for the network setup by the predetermined protocol is Bootstrapping information.

10. The method according to claim 1, wherein
the predetermined protocol is Device Provisioning Protocol (DPP), and
processing for executing the network setup by the predetermined protocol in the information processing apparatus is processing for transmitting information for connection to the access point to the communication apparatus by DPP.

11. The method according to claim 1, wherein processing for executing the network setup by the predetermined protocol in the information processing apparatus is processing for activating an application program for the network setup by the predetermined protocol.

12. The method according to claim 1, further comprising executing processing for executing, based on a fact that the predetermined access point does not support the network setup by the predetermined protocol, a network setup by another protocol different from the predetermined protocol in the information processing apparatus.

13. The method according to claim 12, wherein based on a fact that the communication apparatus does not support the network setup by the predetermined protocol even in a case where the predetermined access point supports the network setup by the predetermined protocol, processing for executing the network setup by the other protocol in the information processing apparatus is executed.

14. The method according to claim 12, wherein the other protocol is one of Port 9100, SNMP, HTTP, and a protocol unique to a vendor of the communication apparatus.

15. The method according to claim 12, wherein
the network setup by the other protocol includes processing of transmitting information for connection to the predetermined access point from the information processing apparatus to the communication apparatus by the other protocol, and
in a case where the network setup by the other protocol is executed, the communication apparatus is connected to the predetermined access point based on the information for connection to the predetermined access point.

16. The method according to claim 1, wherein
the network setup by the predetermined protocol includes processing of transmitting information for connection to the predetermined access point from the information processing apparatus to the communication apparatus by the predetermined protocol, and
in a case where the network setup by the predetermined protocol is executed, the communication apparatus is connected to the predetermined access point based on the information for connection to the predetermined access point.

17. The method according to claim 1, further comprising determining whether the predetermined access point supports the network setup by the predetermined protocol,
wherein the transmission control is executed based on determination that the predetermined access point supports the network setup by the predetermined protocol.

18. The method according to claim 1, wherein based on one of a Probe Response and a beacon received from the predetermined access point, it is determined whether the predetermined access point supports the network setup by the predetermined protocol.

19. The method according to claim 1, further comprising transmitting a print job for causing the communication apparatus to execute printing.

20. The method according to claim 1, further comprising transmitting a scan job for causing the communication apparatus to execute a scan.

21. A non-transitory computer-readable storage medium storing a program configured to cause a computer of an information processing apparatus to function to:
execute, based on a fact that a predetermined access point different from an information processing apparatus capable of wirelessly communicating with a communication apparatus and different from the communication apparatus supports a network setup by a predetermined protocol, transmission control for transmitting, to the communication apparatus, a signal for causing the communication apparatus to start a predetermined operation for the network setup by the predetermined protocol; and
execute processing for executing the network setup by the predetermined protocol in the information processing apparatus.

22. An information processing apparatus capable of wirelessly communicating with a communication apparatus, comprising:
a transmission control unit configured to execute, based on a fact that a predetermined access point different from the information processing apparatus and different from the communication apparatus supports a network setup by a predetermined protocol, transmission control for transmitting, to the communication apparatus, a signal for causing the communication apparatus to start a predetermined operation for the network setup by the predetermined protocol; and
an execution unit configured to execute processing for executing the network setup by the predetermined protocol in the information processing apparatus.
